(19) United States
(12) Patent Application Publication
(10) Pub. No.: US 2003/0043202 A1
(43) Pub. Date: Mar. 6, 2003

(54) Modifying only selected icons on an interactive display screen crowed with icons by rendering the non-selected icons unmodifiable

(75) Inventors: Paul Bernell Finley JR., Austin, TX (US); Michael Douglas Hinegardner, Round Rock, TX (US); Suanne M. Lowe, Austin, TX (US); Jessica Kelley Murillo, Hutto, TX (US); Johnny Meng-Han Shieh, Austin, TX (US)

Correspondence Address: Volel Emile, International Business Machines Corporation, Intellectual Property Law Department, 11400 Burnet Road, Internal Zip 4054, Austin, TX, 78758, US

(73) Assignee: International Business Machines Corporation, Armonk, NY

(21) Appl. No.: 09/942,754

(22) Filed: Aug. 30, 2001

(51) Int. Cl. G09G 5/00

(52) U.S. Cl. 345/810

(57) ABSTRACT

Items such as icons are modified in high icon density environments on the display screen. An implementation combines rendering a set of said items unmodifiable, and then enabling the modifying of a selected item in said set of unmodifiable items. In effect, all of the icons in the high icon density region or sector of the display screen are “frozen” so as to be unmodifiable, and then only a selected or “target” icon is made modifiable or “hot” while the other icons in the sector remain unmodifiable. The rendering of the target icon to be modifiable may involve a simple point and click cursor movement which still is not an easy task in a crowded icon environment. However, once this is accomplished, then the rest of the icon modification is simplified in that the adjacent icons remain frozen in the unmodifiable state. According to an aspect of the invention, the rendering of the set of a cluster of icons unmodifiable includes circumscribing said cluster of icons, preferably using the cursor.

### TECHNICAL FIELD

The present invention relates to user interactive computer supported display technology and particularly to such user interactive systems and methods that are user friendly and provide computer users with an interface environment that is easy to use, even in displays which are crowded and cluttered with icons.

### BACKGROUND OF RELATED ART

The past decade has been marked by a technological revolution driven by the convergence of the data processing industry with the consumer electronics industry. This advance has been even further accelerated by the extensive consumer and business involvement in the Internet or World Wide Web (“Web”) over the past several years. As a result of these changes, it seems as if virtually all aspects of human endeavor in the industrialized world require human-computer interfaces. These changes have made computer directed activities accessible to a substantial portion of the industrial world's population, which, up to a few years ago, was computer-illiterate, or, at best, computer indifferent. In order for the vast computer supported industries and market places to continue to thrive, it will be necessary for increasing numbers of workers and consumers who are limited in computer skills to become involved with computer interfaces.

Despite all of the great changes that have been made in the computer industry, the screen cursor controlled manually by the user still remains the primary human-computer interface. The user still commands the computer primarily through manual pointing devices such as mice, joy sticks and trackballs which control the on-screen cursor movements. It must be noted that the principles involved in such pointing devices were developed over a generation ago when most of the people involved in interfaces to computers were computer professionals who were willing to invest great amounts of time in developing computer skills. It is very possible that had computers originally been the mass consumer, business and industry implements that they are today, user interfaces that were much easier and required less skill to use would have been originally sought and developed. Nonetheless, the manually controlled cursor movement devices are our primary access for cursor control. The present invention is directed to making mouse, trackball and the like cursor control devices more user friendly and effective.

Icons in Graphical User Interfaces (GUIS) are, of course, the primary access through which the user may interactively select substantially all computer functions and data. Thus, the number of icons that the user has to contend with in the navigation of his cursor to his target icon has been greatly increasing. These may be arranged in many layers of windows. In certain portions of the user's display screen, there may be dense populations of icons. The icons may overlap or be stacked one on the other.

In addition, the user's desktop display screens have been increasing in size to thereby provide the user with the luxury of some room for icon spacing to visually separate icons. On the other hand, users are extensively using laptop computers, palm-type devices (including Personal Digital Assistants (PDAs)) and even cell phone displays to supplement their desktops. Thus, the desktop displays need to be replicated on these smaller screen devices to thereby make the icons even more closely spaced.

As significant as problems may be in locating icons and like items in GUI displays, there are even more difficult problems involved in trying to modify such icons or like GUI items in high icon density sections of the display screen. In GUIs it is commonplace for the user to be provided with the facility to modify or otherwise manipulate items such as icons. Such modifications include enlarging or shrinking icon sizes, moving, grouping or ungrouping icons. However, because of the closeness of the surrounding icons, even the simplest of such icon modifications or manipulations becomes quite difficult. Even a skilled cursor user may be attempting to delicately manipulate one object but inadvertently perform an unwanted modification on an object close to the desired object. The user may be attempting to move an object or icon but catch the wrong side of an adjacent object and inadvertently change its size. It is even possible in all of the clutter and potential confusion to end up performing an unintended function on the user's desired or target icon; e.g. the user intends to point the cursor at one side of the object so as to move the object but inadvertently points to the other side of the object which causes the object to commence enlarging.

### SUMMARY OF THE PRESENT INVENTION

The present invention offers a solution for modifying items such as icons in high icon density environments on the display screen. The invention provides the combination of means for rendering a set of these items unmodifiable, and means for enabling the modifying of a selected item in said set of unmodifiable items. In effect, all of the icons in the high icon density region or sector of the display screen are “frozen” so as to be unmodifiable, and then only a selected or “target” icon is made modifiable or “hot” while the other icons in the sector remain unmodifiable. The rendering of the target icon to be modifiable may involve a simple point and click cursor movement which still is not an easy task in a crowded icon environment. However, once this is accomplished, then the rest of the icon modification is simplified in that the adjacent icons remain frozen in the unmodifiable state. According to an aspect of the invention, the rendering of the set of a cluster of icons unmodifiable includes circumscribing said cluster of icons, preferably using the cursor.

### BRIEF DESCRIPTION OF THE DRAWINGS

The present invention will be better understood and its numerous objects and advantages will become more apparent to those skilled in the art by reference to the following drawings, in conjunction with the accompanying specification, in which:

FIG. 1 is a block diagram of a generalized data processing system including a central processing unit that provides the computer controlled interactive display system which may be used in practicing the present invention;

FIG. 2 is a diagrammatic view of a display screen illustrating an example of high density number of icons environment crowded with clusters of icons to which the present invention is applicable;

FIG. 3 is the diagrammatic display view of FIG. 2 but illustrating the action of the cursor in circumscribing a set or high density sector of icons for rendering these icons unmodifiable;

FIG. 4 is a magnified view of the circumscribed sector of unmodifiable icons of FIG. 3;

FIG. 5 is the view of FIG. 4 after the cursor has pointed to and selected a “hot” icon to thereby render the selected icon modifiable;

FIG. 6 is a portion of the view of FIG. 5 magnified even further to illustrate the selected modifiable or “hot” icon;

FIG. 7 is the view of FIG. 6 after the “hot” icon has been modified to enlarge the icon;

FIG. 8 is the view of FIG. 6 after the “hot” icon has been modified to move the icon;

FIG. 9 is a magnified view of a section of a display screen illustrating a high icon density environment wherein the icons are of different types illustrated by their different shapes;

FIG. 10 is a view of a display dialog box which may be used to freeze all of the icons in the high density sector of FIG. 9 and to then inhibit the freezing of icons of one shape type;

FIG. 11 is a flowchart of the program steps involved in setting up a process for freezing the modification of icons in a particular sector of a display screen and then unfreezing selected icons; and

FIG. 12 is a flowchart of the steps involved in an illustrative run of the process set up in FIG. 11.

### DETAILED DESCRIPTION OF THE PREFERRED EMBODIMENT

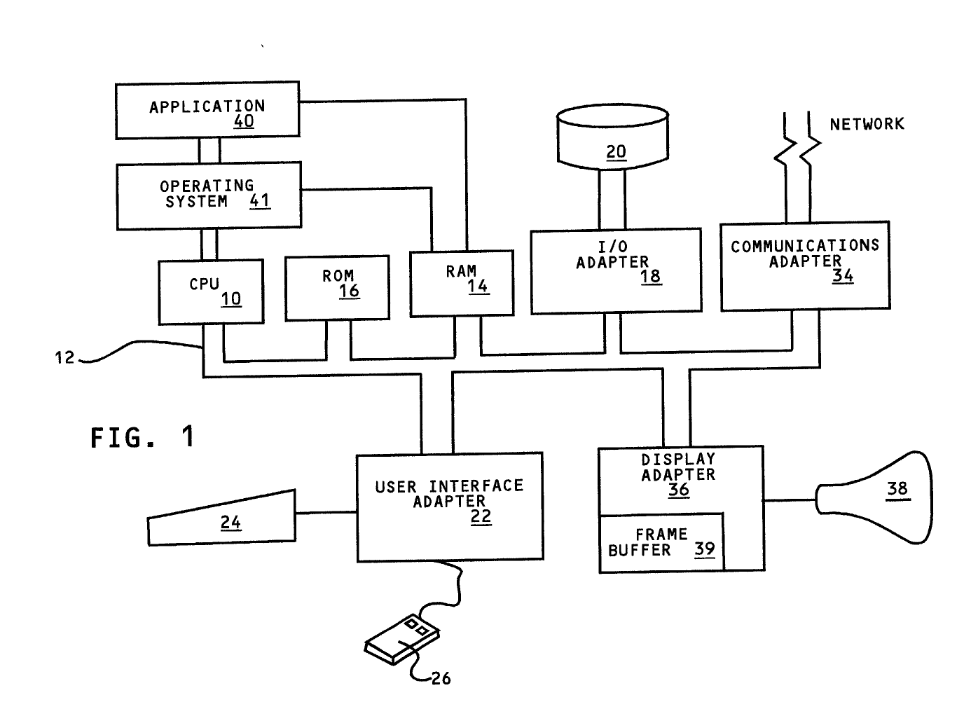

Referring to FIG. 1, a typical data processing system is shown that may function as the computer controlled display terminal used in implementing the system of the present invention of freezing the modification of icons in a particular sector of a display screen and then unfreezing selected icons. A central processing unit (CPU) 10, such as any PC microprocessor in a PC available from International Business Machines Corporation (IBM) or Dell Corp., is provided and interconnected to various other components by system bus 12. An operating system 41 runs on CPU 10, provides control and is used to coordinate the function of the various components of FIG. 1. Operating system 41 may be one of the commercially available operating systems such as Microsoft's Windows98™ or WindowsNT™, as well as the UNIX or IBM's AIX operating systems. An application program for providing for the freezing of the modification of icons in a particular sector of a display screen and then unfreezing selected icons within the frozen sector so that such icons may be modified to be subsequently described in detail, runs in conjunction with operating system 41 and provides output calls to the operating system 41, which, in turn, implements the various functions to be performed by the application 40. A Read Only Memory (ROM) 16 is connected to CPU 10 via bus 12 and includes the Basic Input/Output System (BIOS) that controls the basic computer functions. Random Access Memory (RAM) 14, I/O adapter 18 and communications adapter 34 are also interconnected to system bus 12. It should be noted that software components, including operating system 41 and application 40, are loaded into RAM 14, which is the computer system's main memory. I/O adapter 18 may be a Small Computer System Interface (SCSI) adapter that communicates with the disk storage device 20, i.e. a hard drive. Communications adapter 34 interconnects bus 12 with an outside network enabling the data processing system to communicate with other such systems over a Local Area Network (LAN) or Wide Area Network (WAN), which includes, of course, the Internet. I/O devices are also connected to system bus 12 via user interface adapter 22 and display adapter 36. Keyboard 24 and mouse 26 are all interconnected to bus 12 through user interface adapter 22. Mouse 26 operates in a conventional manner insofar as user movement is concerned. Display adapter 36 includes a frame buffer 39, which is a storage device that holds a representation of each pixel on the display screen 38. Images may be stored in frame buffer 39 for display on monitor 38 through various components such as a digital to analog converter (not shown) and the like. By using the aforementioned mouse or related devices, a user is capable of inputting information to the system through the keyboard 24 or mouse 26 and receiving output information from the system via display 38.

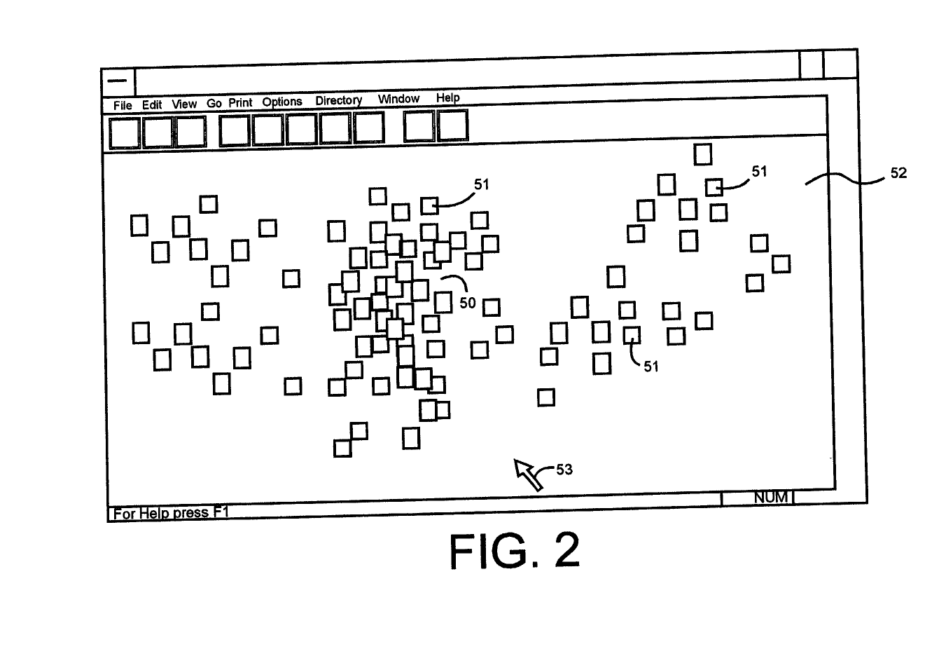

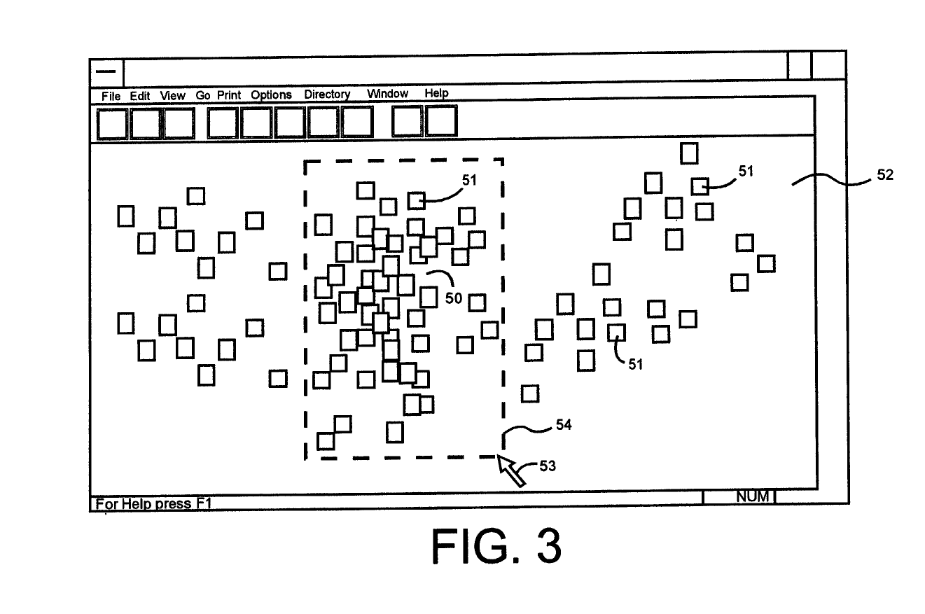

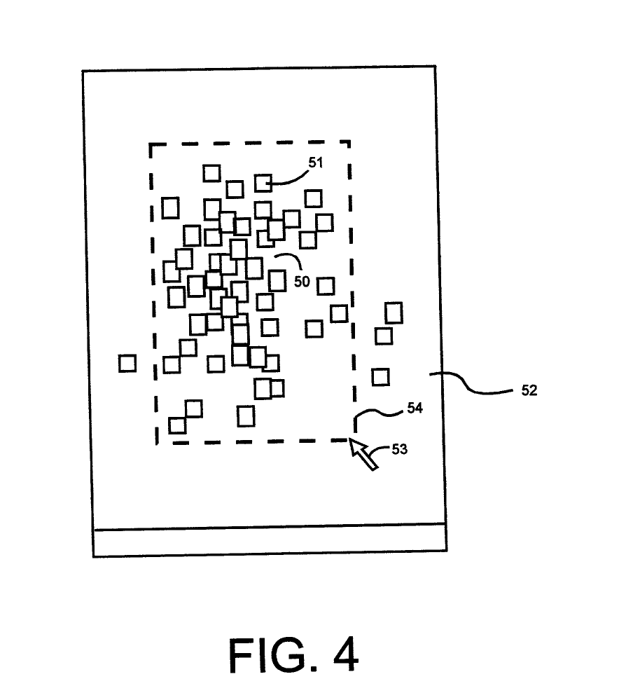

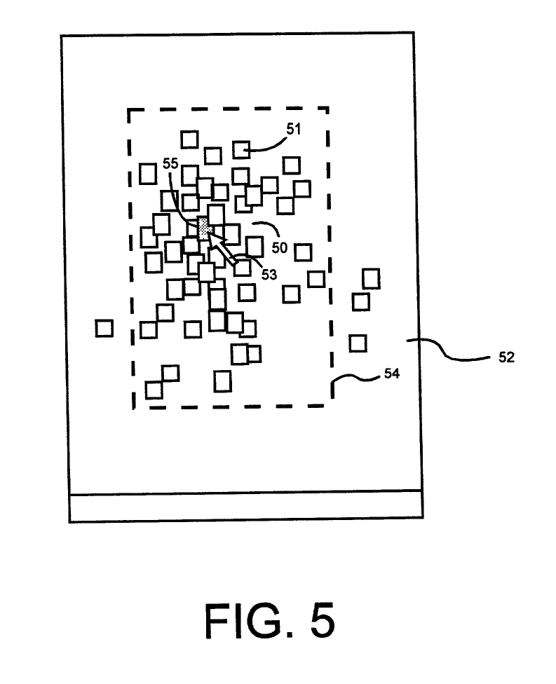

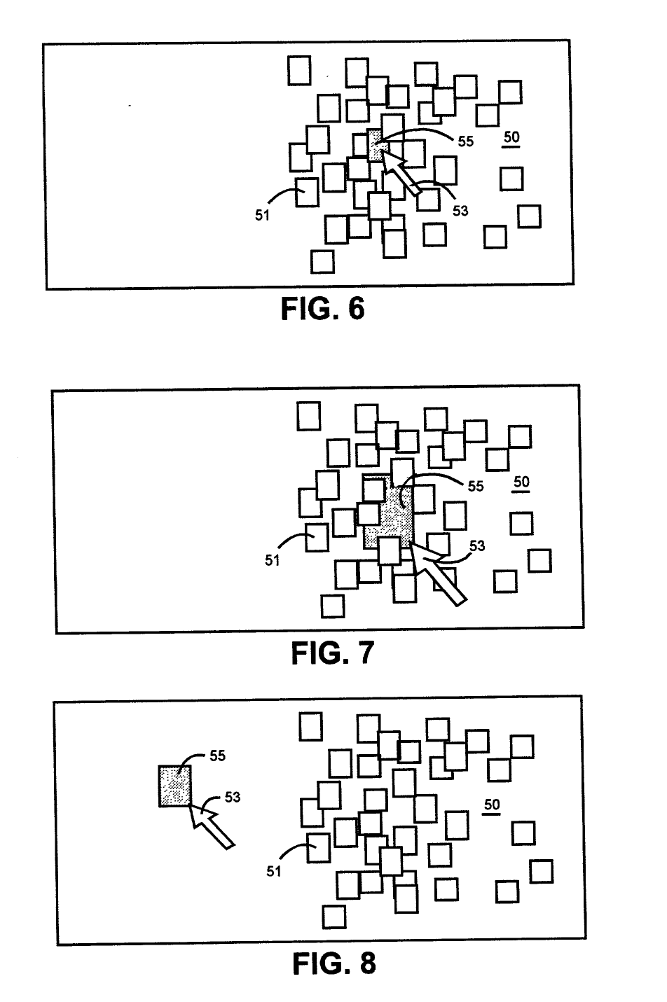

With reference to FIG. 2, the display screen 52 shown has a great number of icons 51 (simplified to just squares for illustration). Actually the number of icons has also been minimized for this example. It is understood that there may be icons arranged in patterns of greater or lesser icon density, i.e. greater spacing between icons. Screen sector 50 is illustrative of a high icon density area. Thus, when the cursor 53 is to be used in a conventional manner to move, enlarge or otherwise modify a selected or target icon, it may be seen that in a high density sector other adjacent icons around the target icon may be inadvertently changed. In accordance with the present invention as shown in FIG. 3, cursor 53 is moved along path 54 to circumscribe all of the icons in screen sector 50. These icons are then rendered unmodifiable or frozen. As shown in an enlarged view of FIG. 4, all icons in circumscribed sector 50 are unmodifiable. At this point, as shown in FIG. 5, the user is permitted to select by pointing and clicking with cursor 53 to an icon 55 which will thereby be rendered “hot” or modifiable. This selected hot icon 55 is shown in further magnified view of FIG. 6. Then for example, only this hot icon 55 may be modified by being resized, enlarged as in FIG. 7 or moved as in FIG. 8.

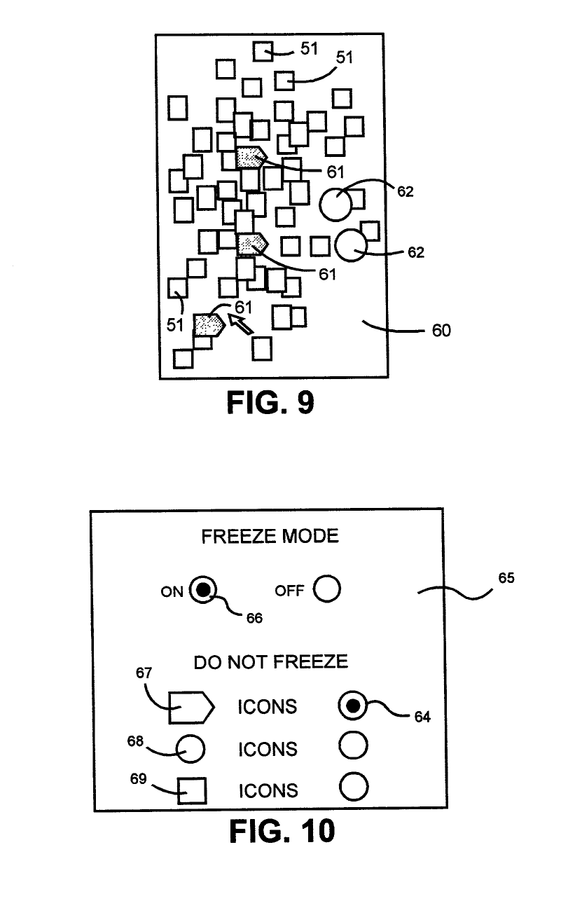

Another aspect of the invention is illustrated with respect to FIG. 9. In an illustrative section of a display screen with a high icon density, there are three different types of icons as indicated by their shapes: rectangular icons 51, circular icons 62 and pentagonal icons 61. The pentagonal icons are shaded to indicate that they are the “hot” icons which are unfrozen and may be modified. The selection shown in FIG. 9 is the result of an illustrative interactive dialog as shown in FIG. 10. The user has selected the “Freeze Mode ON” state 66 in dialog panel 65 and, thus, been offered a choice of non-freezing one of the icon types 67, 68 or 69. The user has selected “Do Not Freeze” 64 the pentagonal icons 67, which has resulted in the status shown in FIG. 9 wherein the user is enabled to only modify icons 61.

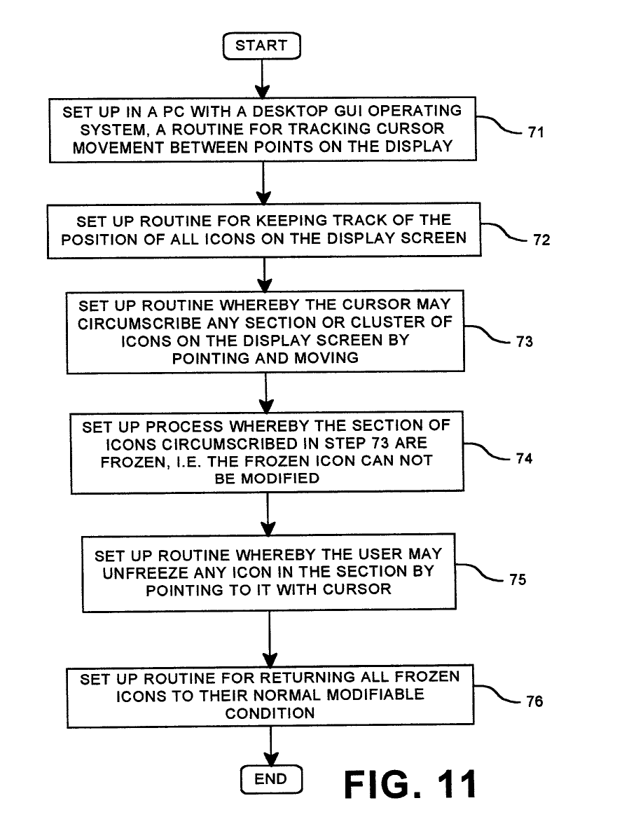

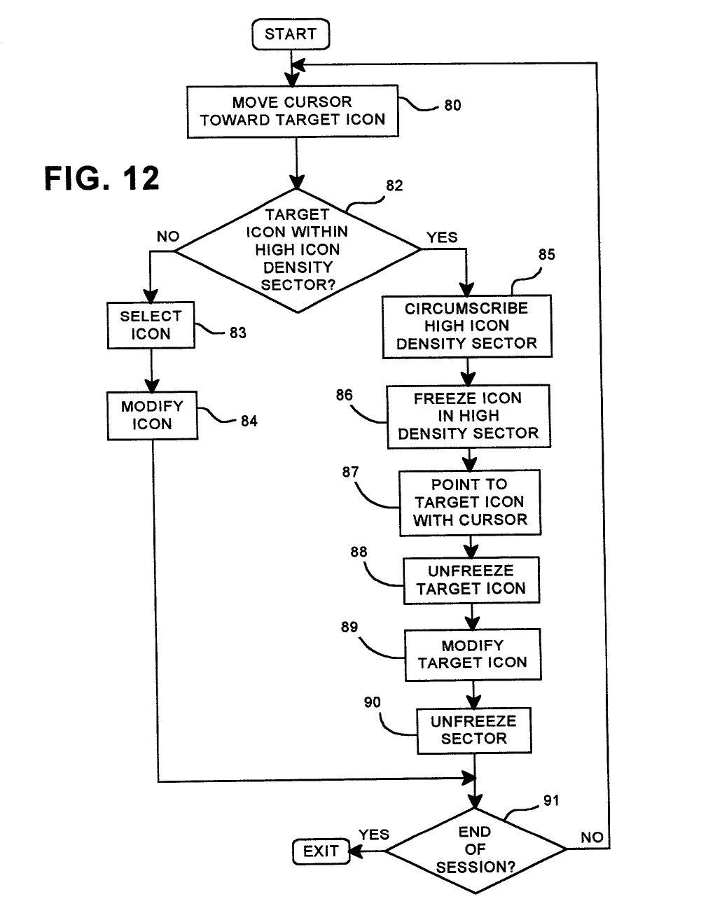

Now, with reference to FIGS. 11 and 12 we will describe a process implemented by the present invention in conjunction with the flowcharts of these figures. FIG. 11 is a flowchart showing the development of a process according to the present invention for the freezing of the modification of icons in a particular high icon density sector of a display screen and then unfreezing selected icons within the frozen sector so that such icons may be modified. In a personal computer set up with a desktop GUI and an operating system, a routine is provided for tracking cursor movements between points on a display screen, step 71. A routine is provided for tracking cursor and icon positions on the display screen, step 72. A routine is set up for the user through cursor movement to circumscribe any section of the display screen containing any cluster icons, step 73. A process is set up wherein the icons circumscribed in step 73 are frozen, i.e. cannot be modified, step 74. Then a routine is set up enabling the user to unfreeze any icon in the circumscribed section by pointing to it with his cursor, step 75, thus making the icon “hot”. The unfrozen or hot icon may then be modified in any conventional manner without affecting any surrounding or adjacent frozen icon. All of the frozen icons may then be returned to their original unmodifiable condition, step 76.

The running of the process will now be described with respect to FIG. 12. First, step 80, the cursor is moved in the direction of a target icon that the user wishes to select. A determination is made with respect to the moving cursor as to whether the target icon is within a high icon density section of the display screen, step 82. The process may use any criteria that the user or process designer may determine for what constitutes a high icon density section, e.g. icons per unit area of the screen, space between icons and/or the extent of icon overlap. A predetermined value for icon density is set up. If Yes, the target icon is within such a high icon density sector of the display screen, then, step 85, the user circumscribes the high density are by using his cursor. The circumscribed icons in the high density area are frozen, i.e. rendered unmodifiable, step 86; the target icon is pointed to with the cursor, step 87; and the target icon is, thus, unfrozen, step 88. The unfrozen target icon is then modified by using any conventional means, step 89. Upon the completion of the modification, the circumscribed icons are unfrozen, step 90. On the other hand if the decision from decision step 82 had been No, the target icon is not in a high density section of the screen, the target icon could be conventionally selected, step 83, and modified, step 84.

At this point, or after step 90, a determination may conveniently be made as to whether the session is over, step 91. If Yes, the session is exited. If No, the process is returned to step 80 where movement of the cursor toward another target icon is commenced.

One of the implementations of the present invention is as an application program 40 made up of programming steps or instructions resident in RAM 14, FIG. 1, during computer operations. Until required by the computer system, the program instructions may be stored in another readable medium, e.g. in disk drive 20 or in a removable memory, such as an optical disk for use in a CD ROM computer input or in a floppy disk for use in a floppy disk drive computer input. Further, the program instructions may be stored in the memory of another computer prior to use in the system of the present invention and transmitted over a LAN or a WAN, such as the Internet, when required by the user of the present invention. One skilled in the art should appreciate that the processes controlling the present invention are capable of being distributed in the form of computer readable media of a variety of forms.

Although certain preferred embodiments have been shown and described, it will be understood that many changes and modifications may be made therein without departing from the scope and intent of the appended claims.

What is claimed is:

1. In a computer controlled user interactive display system, a display interface implementation for enabling an interactive user to modify selected items on a display screen crowded with normally modifiable items comprising: means for modifying said normally modifiable items;
means for rendering a set of said items unmodifiable; and
means for enabling the modifying of a selected item in said set of unmodifiable items.

2. The computer controlled user interactive display system of claim 1 wherein said normally modifiable items are icons.

3. The computer controlled user interactive display system of claim 2 wherein said set of unmodifiable icons is a cluster of adjacent icons.

4. The computer controlled user interactive display system of claim 3 wherein said means for enabling the modifying of a selected icon in said set includes means for pointing to said selected icon.

5. The computer controlled user interactive display system of claim 4 wherein said means for modifying moves said icon.

6. The computer controlled user interactive display system of claim 4 wherein said means for modifying resizes said icon.

7. The computer controlled user interactive display system of claim 4 wherein said means for rendering said set of a cluster of icons unmodifiable includes means for circumscribing said cluster of icons.

8. The computer controlled user interactive display system of claim 7 wherein said means for circumscribing said cluster of icons includes pointing means.

9. The computer controlled user interactive display system of claim 3 further including means for rendering said set of icons to normally modifiable after said selected icon has been modified.

10. A method for enabling an interactive user to modify selected items on a display screen crowded with normally modifiable items in a computer controlled user interactive display system comprising:
means for rendering a set of said items unmodifiable; and
means for enabling the modifying of a selected item in said set of unmodifiable items.

11. The method of claim 10 wherein said normally modifiable items are icons.

12. The method of claim 11 wherein said set of unmodifiable icons is a cluster of adjacent icons.

13. The method of claim 12 wherein said step of enabling the modifying of a selected icon in said set includes the step of pointing to said selected icon.

14. The method of claim 13 wherein said step of modifying said icon moves said icon.

15. The method of claim 13 wherein said step of modifying said icon resizes said icon.

16. The method of claim 13 wherein said step of rendering said set of a cluster of icons unmodifiable includes the step of circumscribing said cluster of icons.

17. The method of claim 16 wherein said step of circumscribing said cluster of icons includes the step of pointing to icons in said cluster.

18. The method of claim 12 further including the step of rendering said set of icons to normally modifiable icons after said selected icon has been modified.

19. A computer program having program code included on a computer readable medium for enabling an interactive user to modify selected items on a display screen crowded with normally modifiable items in a computer controlled user interactive display systems comprising:
means for modifying said normally modifiable items;
means for rendering a set of said items unmodifiable; and
means for enabling the modifying of a selected item in said set of unmodifiable items.

20. The computer program of claim 19 wherein said normally modifiable items are icons.

21. The computer program of claim 20 wherein said set of unmodifiable icons is a cluster of adjacent icons.

22. The computer program of claim 21 wherein said means for enabling the modifying of a selected icon in said set includes means for pointing to said selected icon.

23. The computer program of claim 22 wherein said means for modifying moves said icon.

24. The computer program of claim 22 wherein said means for modifying resizes said icon.

25. The computer program of claim 22 wherein said means for rendering said set of a cluster of icons unmodifiable includes means for circumscribing said cluster of icons.

26. The computer program of claim 25 wherein said means for circumscribing said cluster of icons includes pointing means.

27. The computer program of claim 21 further including means for rendering said set of icons to normally modifiable after said selected icon has been modified.
